(19) United States
(12) Patent Application Publication
(10) Pub. No.: US 2008/0187769 A1
(43) Pub. Date: Aug. 7, 2008

(54) METAL-COATED SUPERABRASIVE MATERIAL AND METHODS OF MAKING THE SAME

(75) Inventors: Gary M. Huzinec, Bloomingdale, NJ (US); Richard M. Andrews, Long Valley, NJ (US); Christopher P. Bieniasz, Parsippany, NJ (US)

Correspondence Address: 3M INNOVATIVE PROPERTIES COMPANY, PO BOX 33427, ST. PAUL, MN, 55133-3427, US

(73) Assignee: 3M Innovative Properties

(21) Appl. No.: 11/691,588

(22) Filed: Mar. 27, 2007

Related U.S. Application Data
(60) Provisional application No. 60/744,785, filed on Apr. 13, 2006.

(51) Int. Cl. B32B 15/04; B05D 3/02; B05D 7/00

(52) U.S. Cl. 428/457; 427/383.1; 427/374.1; 427/383.3; 427/217

(57) ABSTRACT

A method of making metal-coated superabrasive material comprises heating components comprising: superabrasive material, a metal-containing compound that comprises a metal capable of forming at least one of a carbide, boride or nitride, and a reducing agent capable of reducing the metal-containing compound. The components are heated in an inert atmosphere to sufficient temperature and for sufficient time to form metal-coated superabrasive material. The metal-coated superabrasive material is useful in the manufacture of various superabrasive tools.

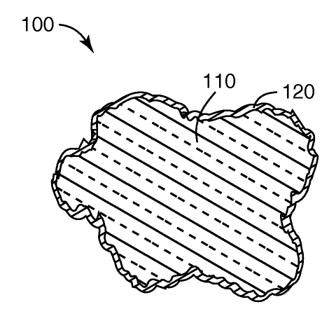

### CROSS-REFERENCE TO RELATED APPLICATION

This application claims the benefit of U.S. Provisional Application No. 60/744,785, filed Apr. 13, 2006.

### BACKGROUND

Superabrasive materials are those materials (e.g., diamond, cubic boron nitride) that have extremely high hardness and are useful for abrading other hard substances. Superabrasive materials are widely used in industry due to their extremely high hardness and, in the case of diamond, very high thermal diffusivity. Superabrasive materials are used in various forms in devices that cut, abrade, shape, or otherwise form almost any engineering material used in industrial manufacturing.

Typically, in the manufacture of such tools the superabrasive material must be bonded to a metal substrate or metal matrix. Since superabrasive materials are not chemically reactive with many desirable metal substrates and matrix metals, it is common practice to coat a layer of metal on the surface of the superabrasive material that chemically bonds to the both the surface of the superabrasive material and to the metal substrate or matrix, as the case may be. If the metal coating is continuous, there is an additional benefit—being able to heat the superabrasive material in air without graphitizing (e.g., in the case of diamond) and oxidizing the surface.

Several methods are known for coating a thin metal layer on the surface of superabrasive material.

Electroless deposition of copper and nickel based alloys is a well-known technique that has been in general use since the 1960's, but this technique typically yields a mechanically bonded metal coating and no chemical bonding whatsoever to the superabrasive material.

Physical Vapor Deposition (PVD) is a method for applying thin metallic coatings using a sputtering process to mechanically convey a metallic vapor to the superabrasive material to be coated. In such a process, the metal, even if reactive to the surface of the superabrasive material, is typically not chemically bonded to the superabrasive surface until a subsequent heat treatment step initiates chemical reaction between the metal coating and the superabrasive material. Further, PVD processes generally require rather expensive PVD deposition equipment.

Chemical Vapor Deposition (CVD) is a method where thermal energy is used to decompose a metallic compound in gaseous form (e.g., tungsten hexafluoride or iron carbonyl) thereby depositing a metal coating onto the surface of superabrasive material. CVD can typically provide a chemically-adherent coating if an appropriately selected metal is used. The CVD process, however, generally requires very complex equipment to control the deposition process, and both the reactant and by-products of the deposition reaction tend to be both highly toxic and can be deleterious to the substrate material.

In another method, a coating of reactive metal particles is adhered to the surface of the superabrasive material, which particles react with the surface of the superabrasive material when heat is applied. Such method typically does not provide a continuous coating, and such coating that forms is typically a very fragile and loosely-adhered.

In yet another method, a mixture of superabrasive material and a metal oxide powder are heated together under an inert atmosphere to provide a coating of the metal on the surface of the superabrasive. That method typically requires the use of temperatures of at least 1000° C. to achieve a good quality adherent metal coating on diamond. Exposing superabrasive materials to such high temperatures typically reduces their strength, especially in the case of synthetic diamond or cubic boron nitride (cBN).

### SUMMARY

In one aspect, the present invention provides a method of making metal-coated superabrasive material, the method comprising:

providing components comprising:
superabrasive material having a surface;
a metal-containing compound that comprises a metal capable of forming at least one of a carbide, boride or nitride;
a reducing agent capable of reducing the metal-containing compound; and

heating the components to at least one temperature above 800° C. while in an inert atmosphere, and

keeping the temperature of the components above 800° C. for sufficient time to deposit an adherent layer of the metal onto at least a portion of the surface of the superabrasive material to form metal-coated superabrasive material, wherein the metal-containing compound has a condensed phase throughout the method.

In another aspect, the present invention provides a method of making metal-coated superabrasive material, the method comprising:

providing components comprising:
superabrasive material having a surface;
a metal-containing compound that comprises a metal capable of forming at least one of a carbide, boride or nitride;
a reducing agent capable of reducing the metal-containing compound; and

heating the components in an inert atmosphere at sufficient temperature, and for sufficient time, to deposit an adherent layer of the metal onto at least a portion of the surface of the superabrasive material to form metal-coated superabrasive material, wherein the reducing agent and the metal-containing compound have a condensed phase throughout the method. In some embodiments, the reducing agent is gaseous (e.g., hydrogen or carbon monoxide).

In some embodiments, the methods further comprise cooling the components (e.g., to ambient temperature) and isolating at least a portion of the metal-coated superabrasive material. In some embodiments, the components are not heated to a temperature greater than 1000° C. In some embodiments, for example, those wherein the reducing agent has a condensed phase throughout the method, at least two of the superabrasive material, the condensed phase of the metal-containing compound, and the condensed phase of the reducing agent do not contact each other. In some embodiments, at least the condensed phase of the metal-containing compound and superabrasive material contact each other. In some embodiments, the superabrasive material comprises at least one of natural diamond, synthetic diamond, or cubic boron nitride. In some embodiments, the superabrasive material comprises superabrasive particles. In some embodiments, the reducing agent comprises a powder (e.g., graphite powder). In some embodiments, at least one metal-containing compound comprises an oxide of at least one of molybdenum, niobium, tantalum, titanium, tungsten, vanadium, or zirconium. In some embodiments, the metal-containing compound comprises at least one of a metal halide or a metal carbonyl. In some embodiments, the adherent layer of the metal is deposited onto substantially all of the superabrasive material. In some embodiments, the inert atmosphere comprises nitrogen, argon, helium, or a combination thereof. In some embodiments, the inert atmosphere has a pressure of less than 100 millipascals (mPa).

Methods according to the present invention are useful, for example, for making metal-coated superabrasive material, which may be further incorporated into a superabrasive tool.

The present invention provides improved methods for coating superabrasive material with metal that result in metal coatings that are strongly adherent, typically chemically bonded, to the superabrasive material. The methods can be practiced with readily available and relatively inexpensive equipment. Advantageously, the methods are effective at temperatures well below those at which significant thermal damage to superabrasive material occurs.

As used herein, “compound” refers to a substance formed by chemical union of two or more elements or ingredients in definite proportion by weight;

“condensed phase” refers to liquid, solid, or a combination of liquid and solid, but does not refer to a gas; and

“metal-coated”, as applied to a surface, means that at least a portion of the surface has a coating of metal thereon.

### BRIEF DESCRIPTION OF THE DRAWING

The drawing is a cross-sectional schematic view of an exemplary metal-coated superabrasive particle made according to a method of the present invention.

### DETAILED DESCRIPTION

Methods according to the present invention are useful, for example, for metal-coating abrasive particles, as shown for example in the drawing, which illustrates a metal-coated superabrasive particle 100 that comprises superabrasive particle 110 and metal coating 120.

Superabrasive materials are widely commercially available and include, for example, diamond (e.g., natural diamond, synthetic diamond, polycrystalline diamond, polycrystalline diamond compacts (PDC), isotopically pure diamond, Chemical Vapor Deposition diamond (CVD diamond), and combinations thereof), any form of cubic boron nitride, and combinations thereof. The superabrasive material may have any size, configuration, and/or shape, or be a combination thereof. For example, the superabrasive material may have the form of particles, sheets, films, whiskers, or a combination thereof. The superabrasive material may be, for example, loose, mounted in a fixture, or partially embedded in a matrix (e.g., a metal matrix). Mixtures of superabrasive materials may be used.

For many applications, the superabrasive material will be in the form of particles. Superabrasive particles for use in finishing and cutting applications are typically graded according to abrasive industry standard grades (e.g., ANSI, FEPA, or JIS), and generally have a characteristic dimension in a range of from about 0.1 micrometer to about 5 millimeters, although larger and smaller particles may also be used. Superabrasive particle size may be selected, for example, by filtering the particles through sieves having precisely sized holes. The term “characteristic dimension” refers to the nominal hole size of a sieve (actual or theoretical) through which particles do or do not pass. In some embodiments, superabrasive particles may have a characteristic dimension in a range of from about 0.1 micrometer to about 1.2 millimeters, for example, in a range of from 45 micrometers to 1.2 millimeters, or 0.1 micrometer to 60 micrometers.

The metal-containing compound is a compound containing at least one metal atom that is able to be reduced to the metal state (zero valence) by the reducing agent. As used herein, the term “compound” refers to a substance formed by chemical union of two or more elements or ingredients in definite proportion by weight. To maximize surface area, the solid metal-containing compounds are typically used in powdered form, although other forms may also be used.

The metal in the metal-containing compound is selected such that it is capable of forming a stable carbide, boride, and/or nitride, the choice typically being further determined by the specific superabrasive material used. The metal should be capable of chemically bonding with the superabrasive surface under conditions used in the method. For example, carbide-forming metals are typically selected for diamond, while boride and/or nitride forming metals are typically selected for cBN. Examples of carbide-forming metals include molybdenum, niobium, tantalum, titanium, tungsten, chromium, hafnium, vanadium, and zirconium. Examples of boride-forming metals include molybdenum, niobium, tantalum, titanium, tungsten, chromium, hafnium, iron, vanadium, and zirconium. Examples of nitride-forming metals include aluminum, hafnium, molybdenum, niobium, tantalum, titanium, tungsten, chromium, vanadium, and zirconium.

Accordingly, useful metal-containing compounds include compounds containing molybdenum, niobium, tantalum, titanium, tungsten, chromium, hafnium, vanadium, zirconium atoms, or a combination thereof. Examples include oxides, phosphates, halides, carbonyl complexes, and nitrile complexes of molybdenum, niobium, tantalum, titanium, tungsten, chromium, hafnium, vanadium, or zirconium, and combinations thereof. Combinations of two or more metal-containing compounds may also be used.

The metal-containing compound is typically selected so that it does not generate materials that interfere substantially with chemical bonding of the corresponding metal with the surface of the superabrasive material. In addition, the selection of the metal-containing compound may depend upon the physicochemical and toxicological properties (e.g., low toxicity and relatively high vapor pressure) at the temperatures used in the method and the chemical reactivity of the reducing agent and surface of the superabrasive material.

The superabrasive material, metal-containing compound, and reducing agent, (which may be solid, liquid, or gaseous) are typically positioned in close proximity to one another and heated within in a restricted volume (e.g., a heating zone of a furnace or oven) to such temperature, and for a sufficient time, that the desired level of coating is formed on the surface of the superabrasive material.

Without wishing to be bound by theory, it is believed that at the elevated temperatures used in methods according to the present invention the metal that is deposited on the superabrasive material first forms a carbide (in the case of diamond) or a boride/nitride (in the case of cBN) that chemically bonds to the surface of the superabrasive material and facilitates strong adhesion (to the surface of the superabrasive material) of any further metal coating that may be subsequently deposited thereon.

In the manufacture of diamond tools, diamonds are typically embedded in a metal matrix; commonly copper, tin, iron, cobalt, nickel, silver, chromium, or an alloy thereof. Compatibility with the metal matrix is a prime consideration in choosing the metal layer on the superabrasive material, and hence the metal-containing compound. Tungsten has a very attractive combination of properties in that its oxide is easily reducible, it forms more than one stable carbide, and also forms a nitride and boride. Further, tungsten oxide has a significant vapor pressure at useful temperatures. The easy availability and relatively high vapor pressure of tungsten trioxide make it a desirable metal-containing compound.

The choice of the metal-containing compound, and its amount, are selected such that it has at least one condensed phase (e.g., solid or liquid) throughout the conditions used to deposit the metal layer on the surface of the superabrasive material. The relative amounts of the metal-containing compound and superabrasive material may typically be varied over a wide range without significant impact on the quality of the metal layer deposited on the surface of the superabrasive material. Typically, the amount of metal-containing compound is on the same order as the amount of superabrasive material, for example, in a range of from 1 to 10 times the weight of the superabrasive material to be treated, although other ratios may also be used.

The reducing agent may be any material that is capable of reducing the metal-containing compound to generate the corresponding metal. The reducing agent may be solid, liquid, a gas, or a combination thereof. Combinations of two or more reducing agents may be used. If a reducing agent is a solid, it is typically used as a powder to increase its surface area. Examples of useful reducing agents include various forms of carbon (e.g., carbon black, lamp black, charcoal, graphite), boron, hydrogen, carbon monoxide, and combinations thereof. The reducing agent, and the amount used, may be selected such that it has at least one condensed phase (e.g., solid or liquid) throughout the conditions used to deposit the metal layer on the surface of the superabrasive material.

Surprisingly, it is found that the reducing agent has the effect of reducing the temperature at which deposition of the metal coating on the surface of the superabrasive material begins, as compared to the temperature of at which deposition begins if the reducing agent is not present. This not only typically reduces the time and energy requirements for the overall process, but it also allows for lower heating temperatures that do not cause significant thermal weakening of the superabrasive material, particularly in the case of synthetic diamonds, which can be a significant problem if the reducing agent is omitted.

The amount of reducing agent is not critical, but should generally be sufficient to lower the process temperature and/or reduce the process duration as compared to carrying the process without the reducing agent. On the other hand, too much reducing agent may impede the process, although the reason for this is not clear since the solid reducing agent appears not to become coated with metal during the process. If the reducing agent is powdered graphite and the metal-containing compound is tungsten oxide, it is typically used in the proportion of 5 parts by weight graphite to 95 parts tungsten oxide.

An inert atmosphere must be maintained during the deposition of the metal layer on the surface of the superabrasive material. For purposes of definition “inert” is taken to mean that the atmosphere (exclusive of components directly resulting from any reducing agent(s), superabrasive material(s), or metal-containing compound(s)) does not materially chemically effect the deposition of metal on the surface of the superabrasive material. The presence of oxygen in amounts greater than about 3 parts per million (ppm) during metal deposition may damage the superabrasive material and inhibit metal deposition. While a static inert atmosphere can typically be used, a slowly flowing inert atmosphere may be a more effective and convenient method for maintaining the very low oxygen levels required. For example, a flowing inert atmosphere has the desirable result of purging any gaseous reaction byproducts that would tend to slow the reaction. Typically, if a flowing inert atmosphere is used, the flow rate should remain relatively low, since at excessive gas velocities there may be a noticeable difference in coating quality between upstream and downstream portions of the superabrasive material.

Inert atmosphere may achieved, for example, by high vacuum (e.g., less than 100 mPa), or by using inert a gas or mixture of gases. Exemplary inert gases include argon, helium, krypton, neon, and nitrogen. Eliminating oxygen by pulling a vacuum typically has the undesirable effect of removing the metal-containing compound and reducing agent, and typically slows the rate of metal deposition.

Typically, methods according to the present invention are practiced within a restricted heated zone of an oven or furnace, and which may open to the surrounding environment as, for example, in the case of a tube furnace, or the heated zone may be entirely enclosed. In general, it is desirable that the heated zone be relatively small to facilitate deposition of the metal layer, and to aid in creating and maintaining an inert atmosphere.

The superabrasive material, metal-containing compound, and reducing agent may be combined, in any order, all together in a single container (e.g., a crucible), or any two of the superabrasive material, metal-containing compound, and reducing agent may be combined while the third component remains separate, or each of the superabrasive material, metal-containing compound, and reducing agent may be placed separately into the heated enclosure (e.g., in separate crucibles). If the reducing agent is gaseous, it may be conveniently added to the heated zone as a blend with inert gas.

In one exemplary embodiment, diamond superabrasive particles are mixed with graphite powder and tungsten trioxide powder in a ratio (by weight) of about 10 parts diamond to about 3 parts graphite to about 60 parts tungsten trioxide in a common crucible, and the crucible is heated. The heating rate is generally not important beyond its obvious influence on the time required to practice the present invention, and as long as an inert atmosphere is maintained.

After coating the superabrasive material with the metal (e.g., in total or in part), the metal-coated superabrasive material may be isolated by any suitable means. If particulate superabrasive material, metal-containing compound and/or reducing agent are used, the particles of superabrasive material may have a different size grade than the metal-containing compound and/or the reducing agent, so simple screening can suffice to separate the reactants from the metal-coated superabrasive material.

Typically, non-gaseous components may be placed in heat resistant crucibles during the methods of the present invention, although this not a requirement. In general, the shape of a crucible containing the superabrasive material to be metal-coated is shallow in order to minimize the depth of the superabrasive material and maximize the surface area of any of the metal-containing compound and/or reducing agent that may be combined therewith, although this is not a requirement. Crucibles may be made of any material that does not adversely impact the coating process and is able to withstand the temperatures involved in the processes of the present invention. In general, ceramic and graphite crucibles have been found to be suitable.

If metal-coating shaped pieces of polycrystalline superabrasive parts, or large natural stones, one useful method includes burying the superabrasive material completely in a mixture of the metal-containing compound and reducing agent. This technique generally can rapidly provide a substantially uniform metal-containing on the superabrasive material.

Once an inert atmosphere has been established (e.g., the atmosphere has been essentially purged of oxygen) the temperature of the heated zone is ramped up to a soak temperature (e.g., at least 800° C.) where is kept for a specified time (soak time), and at which temperature coating occurs.

During this thermal soak portion of the method the temperature may vary or remain constant. The temperature ramp rate is typically raised at a rate that is convenient for the operator and consistent with the longevity of the heating equipment. For example, ramp rates of between 10 and 50° C. per minute are typically useful if using a tube furnace.

The combination of time and temperature during the high temperature portion of the metal-coating cycle typically strongly influence the amount of coating deposited. As a rule, the higher the temperature—the faster metal deposition occurs; however, excessively high temperatures (e.g., temperatures in excess of 1000° C. may lead to a loss of durability of the superabrasive material. For example, most synthetic diamonds begin to lose strength rapidly at temperatures above 1000° C. In such cases, it is typically desirable to carry out the method coat below 900° C. While natural diamonds are much less susceptible to thermal damage than synthetic diamonds, it is still typically desirable to practice the method at as low a temperature as possible since graphitization still can occur. Metal-coating cBN typically requires higher temperatures and longer times than diamond.

Once sufficient time and temperature to produce the desired metal coating thickness and quality has been achieved, the temperature is reduced at a rate that is generally not important and while still under the inert atmosphere, typically to ambient or near ambient temperature. The choice of cooling rate is normally determined by the need to preserve the heating equipment. For example, rapid cooling typically leads to a shorter operational life for most furnaces.

Optionally, oxygen (e.g., air) may be introduced into the heated zone during cooling before the metal-coated superabrasive material has cooled to ambient temperature. This may selectively oxidize at least a portion of the metal layer on the superabrasive material, for example, for use in making a vitrified tool.

Metal-coated superabrasive material may optionally be heated in a reducing atmosphere such as hydrogen or carbon monoxide to brighten the coating by minimizing the oxide layer that inevitably forms on the metal layer if stored in air. However, it is found according to the present invention that the inclusion of the discrete reducing agent into the heated enclosure generally obviates the need for subsequent cleaning steps since the coating is typically very bright. Prolonged storage of metal coated superabrasive in a hot and humid environment, however may lead to the need to re-clean the coated material, and the above method will suffice for this purpose if it becomes necessary.

After cooling, the metal-coated superabrasive material may be separated from the metal-containing compound and reducing agent by sieving as discussed above, by elutriation, or by any other suitable method, many of which processes are well known in the art.

Since metal-coating of the superabrasive material can occur without physical contact between the condensed phase of the metal-containing compound (and optionally a condensed phase of the reducing agent) and the superabrasive material to be coated, it is envisioned that the method could be carried out in a continuous fashion; for example, by using a continuous feed of components into a rotating tube furnace under conditions such that the superabrasive material spends sufficient time in the hot zone to deposit a desired thickness of coating. However, batch methods are generally effective methods for practice the methods of the present invention.

Usually it is desirable to coat the entire surface with metal, but in those cases where only a portion of the surface must be coated a masking layer of non-reactive ceramic ink or paint may be applied to the areas to be protected from the coating. Such barrier coatings are commercially available and typically consist of refractory oxides, borides, nitrides and carbides in a liquid/polymer carrier.

In general only a very thin layer of metal need be deposited on the surface of the superabrasive material in order to realize enhanced bonding to metal matrix materials. Further, since a small amount of the very expensive superabrasive material is typically consumed in the coating process it is also desirable that the coating be very thin. Metal layer thicknesses of less than 1 micrometer in thickness are generally perfectly adequate, and in general, if the coated superabrasive is electrically conductive it is has a sufficient coating thickness.

Metal-coated superabrasive materials, prepared according to methods of the present invention, can be incorporated in the abrasive portion of metal bonded, metal core abrasive tools by various techniques well known in the art. For example, metal-coated superabrasive particles can be combined with particulate components of a metal bond composition, compacted and shaped under pressure, then sintered to form a shaped metal-bonded superabrasive tool. Metal-coated superabrasive particles are also suitable for “hot pressing” involving simultaneous application of heat and pressure to form a shaped metal-bonded superabrasive tool. Metal-coated superabrasive particles may also be utilized in a tool fabrication process wherein metal-coated superabrasive particles are packed in a mold cavity within a powdered matrix of metal bond components, followed by infiltration of interstices in the matrix with a molten, low melting metal or alloy.

Additionally, metal-coated superabrasive materials (e.g., particles) prepared by methods according to the present invention are suitable for attachment to abrasive tools (e.g., as a single layer of metal-coated superabrasive particles on the surface of a metal tool body or core), for example, by electroplating, brazing, or soldering.

Examples of superabrasive tools that may be fabricated using metal-coated superabrasive materials prepared by methods according to the present invention include superabrasive cutting wheels, diamond saw blades and drill bits, single layer superabrasive metal bonded tools, superabrasive grinding wheels, superabrasive machining tools, superabrasive dressing tools, and superabrasive coated abrasive tools and belts.

Objects and advantages of this invention are further illustrated by the following non-limiting examples, but the particular materials and amounts thereof recited in these examples, as well as other conditions and, details, should not be construed to unduly limit this invention.

### EXAMPLES

Unless otherwise noted, all parts, percentages, ratios, etc. in the examples and the rest of the specification are by weight, and all reagents used in the examples were obtained, or are available, from general chemical suppliers such as, for example, Sigma-Aldrich Company, Saint Louis, Mo., or may be synthesized by conventional methods.

### Example 1

ABS-3 diamond (2 g, 25/35 mesh obtained from ABC Superabrasives, Inc., Boca Raton, Fla.) was mixed with 0.6 g of graphite powder (A625 grade from Asbury Graphite Mills, Inc., Asbury, N.J.) and 12 g of tungsten trioxide powder (−325 mesh particle size) and placed in a ceramic crucible. The crucible was placed inside the silica tube of a Lindberg tube furnace with a 4-inch (10 cm) diameter tube and the tube was flushed with pure argon sweep gas. While maintaining a flow of approximately 4 cubic feet per hour (0.1 m³/hr) the furnace was heated up to a soak temperature of 871° C., taking about 1 hour to reach the soak temperature. The furnace was held at the soak temperature for 1 hour prior to cooling. Gas flow was maintained until the furnace cooled to below 100° C., which took about 90 minutes. Upon removal of the crucible from the furnace, the diamonds were separated by sieving from the other powder, and examined. The resultant diamonds were a shiny silver color, and were found to be electrically conductive with a resistance of less than 1 ohm, using a digital multimeter.

### Comparative Example A

The procedure of Example 1 was repeated except that the graphite powder was omitted and the furnace was held at the soak temperature for 4 hours. The resultant diamonds were found to be completely uncoated and still a clear transparent yellow color.

### Example 2

The procedure of Example 1 was repeated except that 3 g of graphite powder was used. The resultant diamonds had a mottled dirty yellow color, and were not electrically conductive.

### Example 3

ABS-3 diamond (2 g, 25/35 mesh obtained from ABC Superabrasives, Inc.) was mixed with 0.6 g of graphite powder (A625 grade from Asbury Graphite Mills) and 12 g of tungsten trioxide powder and placed in a first ceramic crucible.

ABS-3 diamond (2 g, 25/35 mesh obtained from ABC Superabrasives, Inc.) was mixed with 12 g of tungsten trioxide powder and placed in a second ceramic crucible.

Both crucibles were placed inside the silica tube of a Lindberg tube furnace with a 4-inch (10 cm) tube diameter and the tube was flushed with pure argon sweep gas. While maintaining a flow of approximately 4 cubic feet per hour (0.1 m³/hr) the furnace was heated up to a soak temperature of 1000° C., taking about 90 minutes to reach the soak temperature. The furnace was held at the soak temperature for 1 hour prior to cooling. Gas flow was maintained until the furnace cooled to below 100° C., which took about 90 minutes. Upon removal of the crucibles from the furnace the diamonds were separated by sieving from the other powder, and examined. The diamonds obtained from the first crucible were a shiny silver color and were found to be electrically conductive, while the diamonds obtained from the second crucible were a mottled silver and bronze color, and electrically conductive.

### Example 4

The procedure of Example 1 was repeated except that 50 pieces of CVD diamond (1×1×3 mm, obtained from SP3 Inc., Santa Clara, Calif.) were used in place of the ABS-3 diamond. The resultant diamond pieces were a shiny silver color, and were electrically conductive.

### Example 5

The procedure of Example 3 was repeated except that BZN500 cubic boron nitride (40/50 mesh, Diamond Innovations, Worthington, Ohio) was used in place of the ABS-3 diamond. The resultant cBN particles from the crucible without graphite (i.e., the second crucible) were unchanged in color. The cBN from the crucible containing the graphite powder (i.e., the first crucible) had a mottled appearance, but the particles were not yet electrically conductive.

### Example 6

BZN500 cBN (2 g, 40/50 mesh from Diamond Innovations) was mixed with 0.6 g of graphite powder (A625 grade from Asbury Graphite Mills) and 12 g of tungsten trioxide powder (−325 mesh particle size) and placed in a ceramic crucible.

The crucible was placed inside the silica tube of a Lindberg tube furnace with a 4-inch (10 cm) tube diameter and the tube was flushed with pure argon sweep gas. While maintaining a flow of approximately 4 cubic feet per hour (0.1 m³/hr) the furnace was heated up to a soak temperature of 1000° C., taking about 90 minutes to reach the soak temperature. The furnace was held at the soak temperature for 4 hours prior to cooling. Gas flow was maintained until the furnace cooled to below 100° C., which took about 90 minutes. Upon removal of the crucibles from the furnace the cBN particles were separated by sieving from the other powder, and examined. The cBN surfaces were slightly darkened and mottled, indicating a more extensive reaction had occurred than in Example 5. The coating, however had a conductivity in excess of 10 Ohms. Surface analysis using Energy Dispersive X-ray Spectroscopy showed a very strong tungsten spectrum, indicating that a metal coating had indeed been applied.

### Example 7

Samples of ABS-3 diamond in the sizes 25/35, 80/100, 170/200, and ABS-2 diamond in 230/270 grit (obtained from ABC Superabrasives, Inc., Boca Raton, Fla.) were tested for friability after various heat exposures as reported in Table 1. The heat treatments were carried out generally according to the procedure in Example 1, except using the soak temperatures reported in Table 1. The relative proportion of diamond, graphite and tungsten trioxide, for those heat treatments where coating was performed, are reported in Table 1.

Friability strength testing was carried out according to test method ANSI B74.23-1999 (a vibratory impact test method). The number of seconds required to crush 50% of the diamonds below a given size (the sieve sizes being defined in the test procedure for each grit size of diamond being tested) is reported in Table 1. A higher number of seconds indicates a stronger (less friable) diamond.

TABLE 1

| | | | Amount of | | Friability |
|---|---|---|---|---|---|
| | Amount of | Amount of | Tungsten | | Strength |
| Diamond | Diamond, | Graphite, | Oxide, | Heat | Test, |
| Type | g | g | g | Treatment | seconds |
| ABS-3, | 2 | 0 | 0 | None | 21.3 |
| 25/35 | | | | | |
| mesh | | | | | |
| ABS-3, | 2 | 0 | 0 | 1000° C. | 10.6 |
| 25/35 | | | | heat only, | |
| mesh | | | | no coating | |
| ABS-3, | 2 | .6 | 12 | Coated at | 9.9 |
| 25/35 | | | | 1000° C. | |
| mesh | | | | | |
| ABS-3, | 2 | .6 | 12 | Coated at | 12.4 |
| 25/35 | | | | 871° C. | |
| mesh | | | | | |
| ABS-3, | 2 | .6 | 12 | Coated at | 12.5 |
| 25/35 | | | | 815° C. | |
| mesh | | | | | |
| ABS-3, | 2 | 0 | 0 | None | 150 |
| 80/100 | | | | | |
| mesh | | | | | |
| ABS-3, | 2 | .6 | 12 | Coated at | 125 |
| 80/100 | | | | 871° C. | |
| mesh | | | | | |
| ABS-3, | 2 | 0 | 0 | None | 182 |
| 170/200 | | | | | |
| mesh | | | | | |
| ABS-3, | 2 | .6 | 12 | Coated at | 182 |
| 170/200 | | | | 871° C. | |
| mesh | | | | | |
| ABS-2, | 2 | 0 | 0 | None | 180 |
| 230/270 | | | | | |
| mesh | | | | | |
| ABS-2, | 2 | .6 | 12 | Coated at | 230 |
| 230/270 | | | | 871° C. | |
| mesh | | | | | |

### Example 8

ABS-3 diamond (1 g, 25/35 mesh) was mixed with 0.3 g of graphite powder (A625 grade from Asbury Graphite Mills) and 6 g of molybdenum oxide powder (−200 mesh particle size from Cerac Inc, Milwaukee, Wis.) and placed in a ceramic crucible. The crucible was placed inside the silica tube of a Lindberg tube furnace with a 4-inch (10-cm) diameter tube and the tube was flushed with pure argon sweep gas. While maintaining a flow of approximately 4 cubic feet per hour (0.1 m³/hr) the furnace was heated up to a soak temperature of 1000° C., taking about 1 hour to reach the soak temperature. The furnace was held at the soak temperature for 4 hours prior to cooling. Gas flow was maintained until the furnace cooled to below 100° C., which took about 90 minutes. Upon removal of the crucible from the furnace, the diamonds were separated by sieving from the other powder, and examined. The diamonds were a dark gray color, but appeared to not be electrically conductive.

### Example 9

BZN500 cubic boron nitride (1 g, 45/50 mesh from Diamond Innovations Inc.) was mixed with 0.3 g of graphite powder (A625 grade from Asbury Graphite Mills) and 6 g of vanadium oxide powder (−200 mesh particle size from Cerac Inc.) and placed in a ceramic crucible. In a second crucible BZN 500 cBN (1 g, 45/50 mesh) was mixed with 6 g of vanadium oxide powder. The crucibles were placed inside the silica tube of a Lindberg tube furnace with a 4-inch (10 cm) diameter tube and the tube was flushed with pure argon sweep gas. While maintaining a flow of approximately 4 cubic feet per hour the furnace was heated up to a soak temperature of 1000° C., taking about 1 hour to reach the soak temperature. The furnace was held at the soak temperature for 4 hours prior to cooling. Gas flow was maintained until the furnace cooled to below 100° C., which took about 90 minutes. Upon removal of the crucible from the furnace, it was clear that a very severe reaction had occurred in the crucible without the graphite in that a solid sintered mass has resulted from a strong reaction between the oxide and the cBN. The crucible containing the graphite mix was easily separable, but surface reaction appeared to be incomplete, in that the grains were nonconductive.

Various modifications and alterations of this invention may be made by those skilled in the art without departing from the scope and spirit of this invention, and it should be understood that this invention is not to be unduly limited to the illustrative embodiments set forth herein.

What is claimed is:

1. A method of making metal-coated superabrasive material, the method comprising:
providing components comprising:
superabrasive material having a surface;
a metal-containing compound that comprises a metal capable of forming at least one of a carbide, boride or nitride;
a reducing agent capable of reducing the metal-containing compound; and
heating the components to at least one temperature above 800° C. while in an inert atmosphere, and keeping the temperature of the components above 800° C. for sufficient time to deposit an adherent layer of the metal onto at least a portion of the surface of the superabrasive material to form metal-coated superabrasive material, wherein the metal-containing compound has a condensed phase throughout the method.

2. A method according to claim 1, further comprising:
cooling the metal-coated superabrasive material to ambient temperature; and
isolating at least a portion of the metal-coated superabrasive material.

3. A method according to claim 2, further comprising contacting the metal-coated superabrasive material with oxygen, under conditions sufficient to oxidize at least a portion of the adherent layer of the metal, during the step of cooling the metal-coated superabrasive material to ambient temperature.

4. A method according to claim 1, wherein the reducing agent has a condensed phase throughout the method, wherein at least two of the superabrasive material, the condensed phase of the metal-containing compound, and the condensed phase of the reducing agent do not contact each other.

5. A method according to claim 1, wherein at least the superabrasive material and the condensed phase of the metal-containing compound contact each other.

6. A method according to claim 1, wherein the superabrasive material comprises diamond.

7. A method according to claim 1, wherein the superabrasive material comprises synthetic diamond.

8. A method according to claim 1, wherein the superabrasive material to be coated comprises cubic boron nitride.

9. A method according to claim 1, wherein the superabrasive material comprises superabrasive particles.

10. A method according to claim 1, wherein the components are not heated to a temperature greater than 1000° C.

11. A method according to claim 1, wherein the reducing agent is gaseous.

12. A method according to claim 1, wherein the reducing agent comprises hydrogen or carbon monoxide.

13. A method according to claim 1, wherein the reducing agent comprises a powder.

14. A method according to claim 1, wherein the reducing agent comprises graphite.

15. A method according to claim 1, wherein the metal-containing compound comprises an oxide of at least one of molybdenum, niobium, tantalum, titanium, tungsten, vanadium, or zirconium.

16. A method according to claim 1, wherein the metal-containing compound comprises a metal halide or a metal carbonyl.

17. A method according to claim 1, wherein the adherent layer of the metal is deposited onto substantially all of the superabrasive material.

18. A method according to claim 1, wherein the inert atmosphere comprises nitrogen, argon, helium, or a combination thereof.

19. A method according to claim 1, wherein the inert atmosphere has a pressure of less than 100 mPa.

20. Metal-coated superabrasive material made according to the method of claim 1.

21. A superabrasive tool comprising metal-coated superabrasive material made according to the method of claim 1.

22. A method of making metal-coated superabrasive material, the method comprising:
providing components comprising:
superabrasive material having a surface;
a metal-containing compound that comprises a metal capable of forming at least one of a carbide, boride or nitride;
a reducing agent capable of reducing the metal-containing compound; and
heating the components in an inert atmosphere at sufficient temperature, and for sufficient time, to deposit an adherent layer of the metal onto at least a portion of the surface of the superabrasive material to form metal-coated superabrasive material, wherein the reducing agent and the metal-containing compound have a condensed phase throughout the method.

23. A method according to claim 22, further comprising:
cooling the metal-coated superabrasive material to ambient temperature; and
isolating at least a portion of the metal-coated superabrasive material.

24. A method according to claim 23, further comprising contacting the metal-coated superabrasive material with oxygen, under conditions sufficient to oxidize at least a portion of the adherent layer of the metal, during the step of cooling the metal-coated superabrasive material to ambient temperature.

25. A method according to claim 22, wherein at least two of the superabrasive material, the condensed phase of the metal-containing compound, and the condensed phase of the reducing agent do not contact each other.

26. A method according to claim 22, wherein at least the condensed phase of the metal-containing compound and the superabrasive material contact each other.

27. A method according to claim 22, wherein the superabrasive material comprises diamond.

28. A method according to claim 22, wherein the superabrasive material comprises synthetic diamond.

29. A method according to claim 22, wherein the superabrasive material to be coated comprises cubic boron nitride.

30. A method according to claim 22, wherein the superabrasive material comprises superabrasive particles.

31. A method according to claim 22, wherein the components are not heated to a temperature greater than 1000° C.

32. A method according to claim 22, wherein at least a portion of the reducing agent is gaseous.

33. A method according to claim 22, wherein the reducing agent comprises hydrogen or carbon monoxide.

34. A method according to claim 22, wherein the reducing agent comprises a powder.

35. A method according to claim 22, wherein the reducing agent comprises graphite.

36. A method according to claim 22, wherein the metal-containing compound is solid.

37. A method according to claim 22, wherein the metal-containing compound comprises an oxide of at least one of molybdenum, niobium, tantalum, titanium, tungsten, vanadium, or zirconium.

38. A method according to claim 22, wherein the metal-containing compound comprises a metal halide or a metal carbonyl.

39. A method according to claim 22, wherein the adherent layer of the metal is deposited onto substantially all of the superabrasive material.

40. A method according to claim 22, wherein the inert atmosphere comprises nitrogen, argon, helium, or a combination thereof.

41. A method according to claim 22, wherein the inert atmosphere has a pressure of less than 100 mPa.

42. Metal-coated superabrasive material made according to the method of claim 22.

43. A superabrasive tool comprising metal-coated superabrasive material made according to the method of claim 22.
